(19) United States
(12) Patent Application Publication
(10) Pub. No.: US 2009/0324352 A1
(43) Pub. Date: Dec. 31, 2009

(54) DRILLING AND SUCTION APPARATUS HAVING A GRIPPING DEVICE

(76) Inventor: Josef Dagn, Kossen (AT)

Correspondence Address: KLEIN, O'NEILL & SINGH, LLP, 43 CORPORATE PARK, SUITE 204, IRVINE, CA, 92606, US

(21) Appl. No.: 12/299,591

(22) PCT Filed: Apr. 27, 2007
(86) PCT No.: PCT/EP2007/003768

§ 371 Date: Mar. 30, 2009

(30) Foreign Application Priority Data
May 11, 2006 (DE) 20 2006 007 577.1

(51) Int. Cl. B23B 39/06

(52) U.S. Cl. 408/72 R

(57) ABSTRACT

The invention relates to a drilling and suction apparatus having a gripping device, especially for opening shock absorbers, spring struts and the like by drilling, comprising a housing having a longitudinal bore for housing a tension bolt which engages with a threaded spindle drivable in both rotating directions by a driving means, wherein at the front end of the tension bolt gripping claw is fixed. and wherein at the housing a holder for the drilling and suction apparatus is formed.

The invention relates to a drilling and suction apparatus having a gripping device by means of which shock absorbers or a spring strut of a motor vehicle or an approximately cylindrical container is opened by drilling radially so that thereafter the liquid contained therein can be drawn off.

DE 199 22 159 shows such a drilling and suction apparatus represented in FIG. 11, wherein a manually operated vice-grip wrench 3 is provided as a gripping means which, by means of gripper jaws 3.1 and 3.2, grips a spring strut I from which liquid contained therein is to be drawn off. At 3.3, the vice-grip wrench is provided with an adjusting screw, and at 4 it is coupled to a component 5 of a duct casing. Fluid connections are designated at 7 and 8. On the opposite front end 6 of the duct casing 2, a tensioning device 9 is arranged in the form of a feed gun with a feed lever 9.1, a return lever 9.2 and a return button 9.3. By means of this feed gun a drilling apparatus B is pressed onto the spring strut 1. The pressurised air-driven drilling apparatus B is provided with a pressurised air connection B1. In this known configuration, fixing at tile spring strut 1 or at a shock absorber by means of the vice-grip wrench 3 is relatively complicated and time-consuming, wherein the pressing of the drill to the circumference of the spring strut must be performed manually by means of the feed gun.

It is the object of the invention to form such a drilling and suction apparatus such that it can be applied in a fast and stable manner to a shock absorber or spring strut and securely fixed thereto. Further, manual operation is to be dispensed with to a large extent.

This is achieved according to the invention by a drilling apparatus according to claim 1. By means of the gripping device which has a gripping claw operated by a driving means, a shock absorber or a spring strut can be quickly clasped and pulled tight by the driving means, whereupon the drilling and suction process can proceed. By switching the driving means, the drilling apparatus can also be quickly released after suctioning, by moving the gripping claw out.

The prestroke and return stroke of the drill is also performed by a driving means, so manual operation is dispensed with.

An exemplary embodiment of the invention is explained in more detail below with reference to the drawing, in which

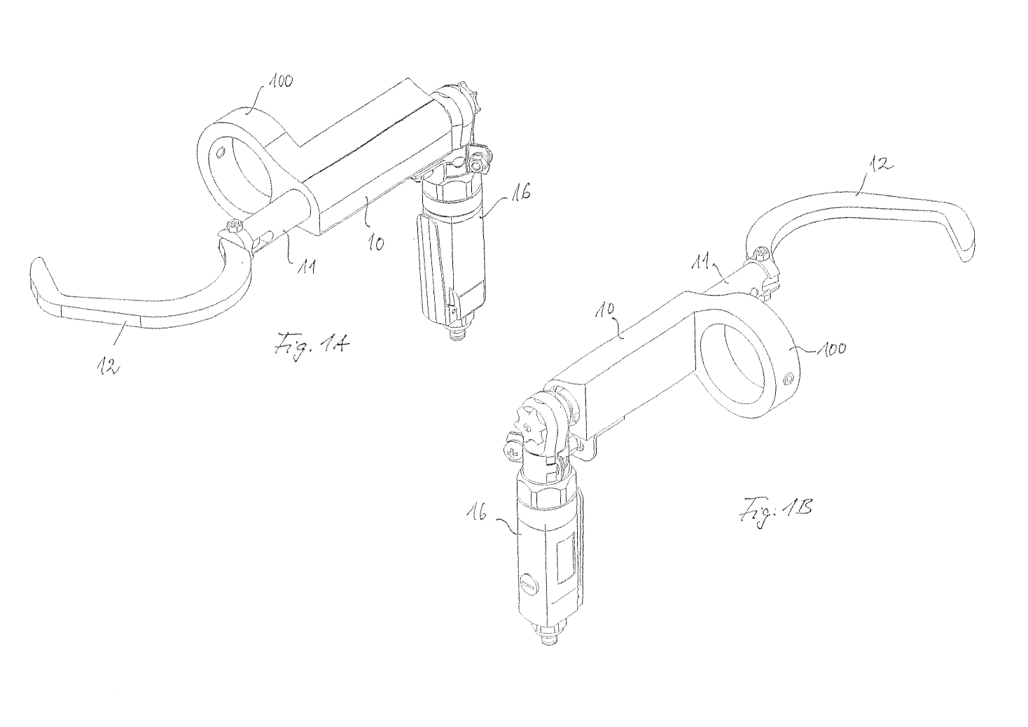

FIG. 1 shows perspective views of the gripping device,

FIG. 2 shows an exploded view of the component parts of the gripping device.

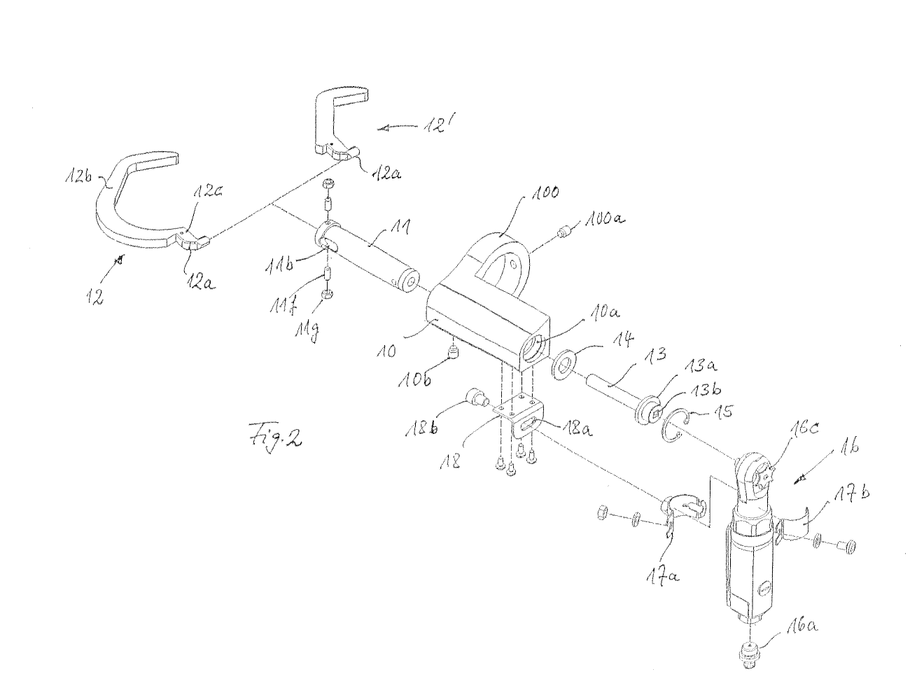

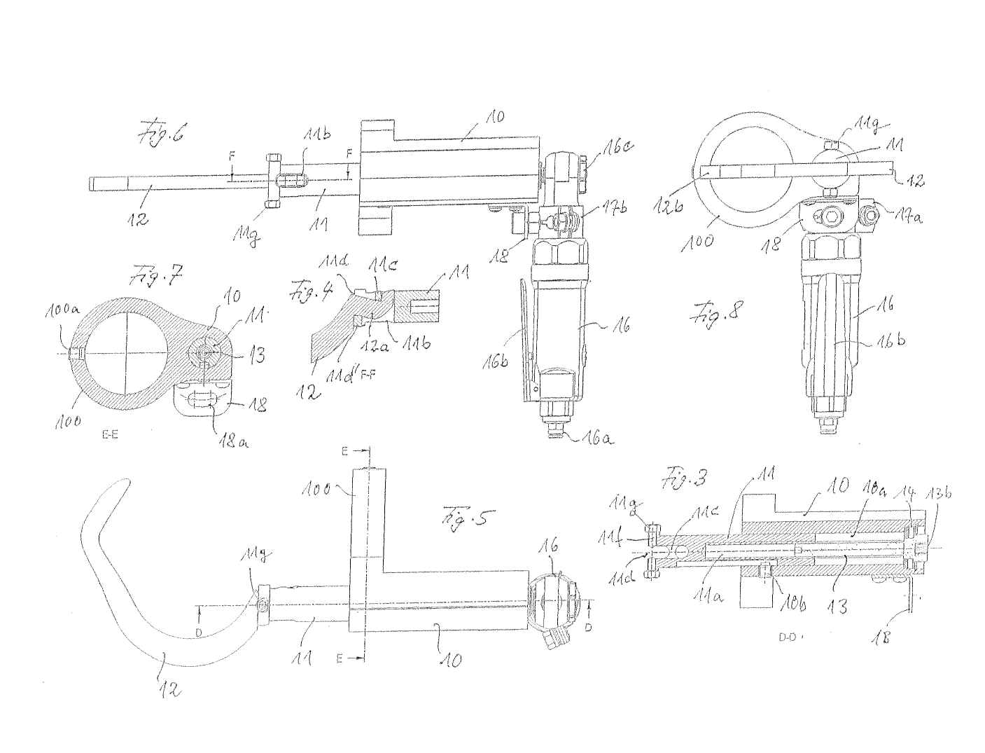

FIG. 3 shows a longitudinal section through the gripping device along the line D-D in FIG. 5,

FIG. 4 shows a partial section through the retainer of the gripping claw along the line F-F in FIG. 6,

FIG. 5 shows a plan view of the gripping device,

FIG. 6 shows a side view of the gripping device,

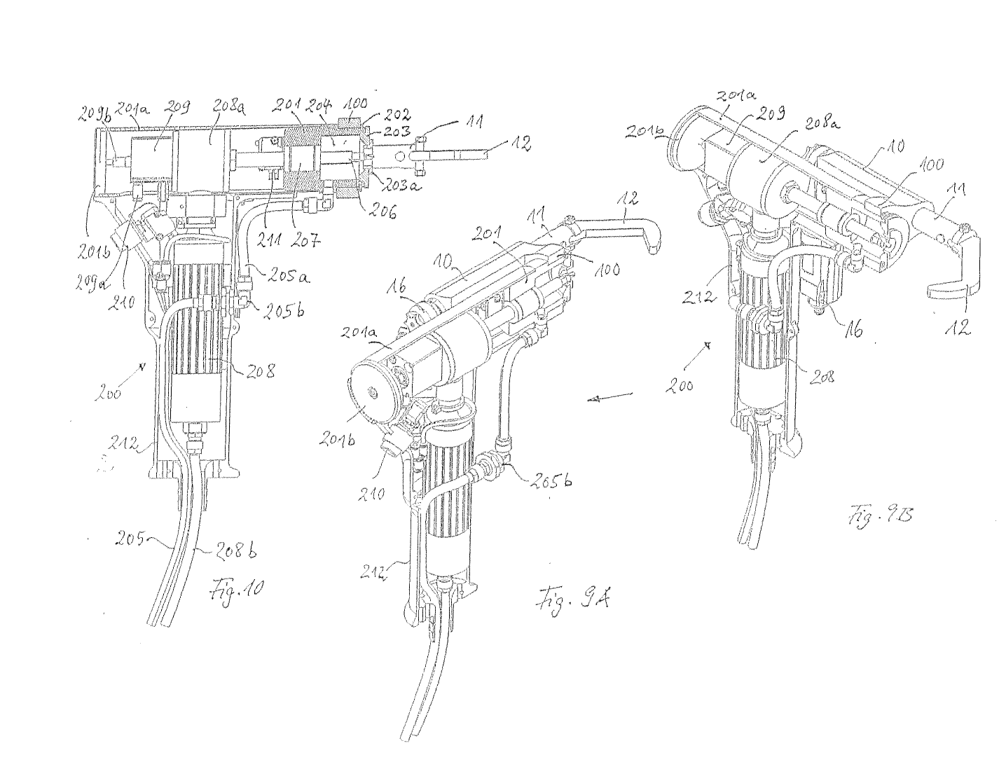

FIG. 7 shows a transverse section along the line E-E in FIG. 5,

FIG. 8 shows a view from the left in FIGS. 5 and 6,

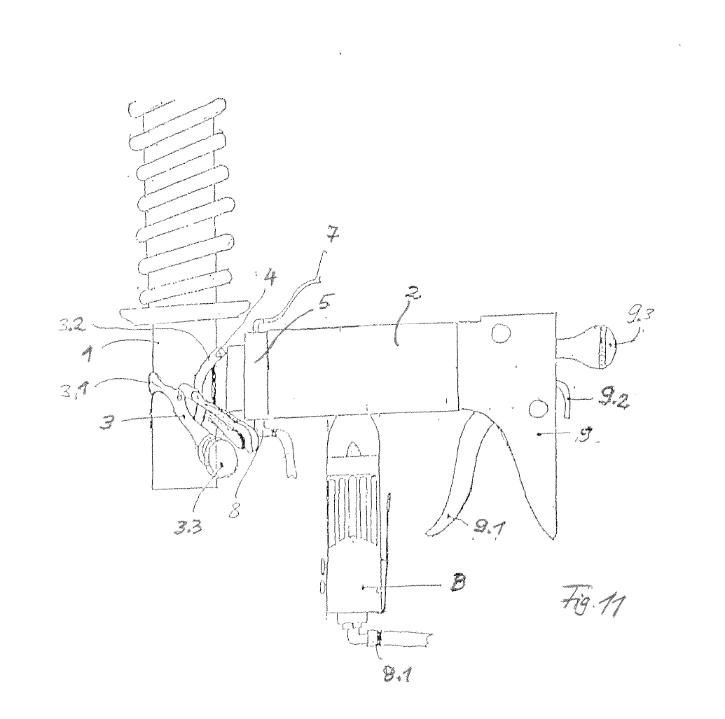

FIG. 9 shows perspective views of the drilling and suction apparatus at the gripping device,

FIG. 10 shows the apparatus with a partial section in the area of the gripping device, and

FIG. 11 shows a known drilling and suction apparatus.

FIGS. 1A and 1B show a gripping device from opposite sides. At 10, an elongate housing is designated, at whose front end a laterally protruding annular holder 100 is integrally formed. On the front end of the housing 10, a tension bolt 11 protrudes, to which a gripping claw 12 is fixed. On the opposite front end of the housing 10, a driving means 16 is mounted in the form of a pressurised air-driven ratchet. The annular holder 100 on the housing 10 houses the drilling and suction apparatus 200 shown in FIGS. 9 and 10, as explained in more detail below.

As FIGS. 2 and 3 show, a longitudinal bore 10a is formed in the housing 10 for housing the tension bolt 11, at whose front end the gripping claw 12 is releasably fixed. The tension bolt 11 guided in the housing 10 is provided with a threaded bore 11a, in which a threaded spindle 13 engages. which is supported by means of a collar 13a at a shoulder in the housing bore 10a over a washer 14. A spring ring is designated by 15, by means of which the threaded spindle 13 is fixed in the housing 10, as FIG. 3 shows. An engaging portion 13b, located on the outer front end of the threaded spindle 13, engages with the driving means 16. As FIG. 3 shows, a longitudinal groove is formed in the tension bolt 11, into which a headless screw 10b screwed into the housing 10 engages so that the tension bolt 11 moves forwards and backwards in the axial direction during the rotational movement of the threaded spindle 13.

In the embodiment shown, the driving means 16 is formed as a pressurised air-driven ratchet, which is provided with a forward and backward motion switch and a pressurised air connection 16a. A handhold 16b of an operating switch is provided for switching the ratchet on and off. A switch button 16c for forward and backward motion is provided. The approximately cylindrical housing of the ratchet 16 is fixed by means of a clamp 17a, 17b to an angle piece 18, which is fixed by means of screws to the lower side of the housing 10. and has a transverse longitudinal hole 18a through which a screw 18b engages in a lug of clamp part 17a. By means of this, the ratchet 16 can be laterally moved somewhat relative to the housing 10, so that on pulling the gripping claw 12 tight, no fixing of the ratchet 16 can occur and a change-over of the running direction is possible.

FIG. 4 shows in a partial section through the front end of the tension bolt 11 the type of fixation of the gripping claw 12. The front end of the tension bolt 11 has at a distance from the front end a throughhole 11b in the transverse direction, which is open on one side in the form of a longitudinal hole and on the opposite side has a bar 11c dividing the throughhole. On the front end, an opening 11d (FIG. 3) extending transverse to the axial direction is formed, which in FIG. 4 is open at the top and merges into the transversely extending throughhole 11b. The bent end 12a of the gripping claw 19 is inserted through this front end opening 11d, such that the bent end portion encompasses the bar 11c, and the opposite side of the engaging portion is supported on the bar 11d′, as FIG. 4 shows.

The throughhole 11b in the transverse direction and the front end opening 11d are formed essentially by a front end of the tension bolt 11 which is slit in a U-shape, wherein two bars 11c and 11d′ are provided offset to one another in the axial direction and arranged on opposite sides of the axis (FIG. 4). These bars 11c and 11d′ in the U-shaped recess at the front end of the tension bolt 11 can also be formed by pins which are inserted transverse to the U-shaped recess.

By inclining the gripping claw 12 upwards in FIG. 4 transverse to the longitudinal axis of the tension bolt, the gripping claw 12 can be released from the tension bolt 11, so that another gripping claw 12′ (FIG. 2) can be inserted, which has the same engaging portion 12a but otherwise has a different shape of gripping bracket 12b. FIG. 2 shows a gripping claw 12 for a larger diameter of a spring strut 1 and a gripping claw 12′ for a smaller diameter.

In order to fix the gripping claw 12 in the tension bolt 11, on opposite sides of the front end opening 11d, by means of a screw 11g (FIGS. 2 and 3), ball stops 11f are inserted in radial bores which engage with a hemispherical recess 12c at the engagement portion 12a of the gripping claw 12. By means of these ball stops 11f, 12c, the gripping claw 12 is reliably fixed in the tension bolt 11, although the gripping claw 12 can easily be released from the tension bolt 11 by inclining laterally to release the notch, and can be withdrawn through the front end opening 11d.

The engaging means of the tension bolt 11 for the gripping claw 12 is aligned such that the gripping bracket 12b protrudes laterally on the side of the tension bolt 11 on which the annular holder 100 is formed on the housing 10, as FIGS. 5 and 8 show, so that the longitudinal axis of the drill 206 (FIGS. 9, 10) approximately meets the middle of the gripping bracket 12b of the gripping claw.

FIGS. 9 and 10 show the drilling and suction apparatus 200 in connection with the gripping device according to FIGS. 1 to 8. The device 200 has a tubular component 201, which is inserted in the annular holder 100 of the gripping device and secured by a spring ring 202 (FIG. 10). A headless screw 100a (FIG. 2) fixes the component part 201 in the holder 100.

The open front end of the tubular component part 201 is provided with an annular cover 203 in whose central opening a rubber gasket 203a is inserted, which comes to bear on the circumference of the shock absorber or spring strut 1. The front portion of the component part 201 forms a suction chamber 204, at which a suction pipe 205 is connected whose portion 205a is formed transparent, so that drawing-off can be monitored.

At the tubular component part 201, a guide casing 201a is fixed. in which a drill head 208a of a drilling apparatus 208 driven by pressurised air is displaceable in the axial direction. A pressurised air pipe is designated by 208b.

In component part 201, a drill 206 is arranged which is guided displaceably by means of a sealing portion 207 in component part 201, on whose circumference sealing rings are provided for sealing the suction chamber 204 off from the drill apparatus. The drill 206 is inserted in the drill head 208a of the drilling apparatus 208, on whose rear side a pressurised air cylinder 209 with connecting lines 209a is mounted, through which the drill head 208a together with the drill apparatus 208 can be moved forwards and backwards relative to the component part 201 and to the cylindrical guide housing 201a mounted thereon. The plunger 209b of this pressurised air cylinder 209 is supported on a rear wall 201b of the guide housing 201a for displacing the drill head.

The guide housing 201a is open at the bottom side. The drilling apparatus 208 is surrounded by a housing 212 which, together with the drilling apparatus 208, the drill head 208a and the cylinder 209 driven by pressurised air can be displaced relative to the component 201 and the guide housing 201a in the axial direction.

A key switch 210 is provided at the housing 212, by means of which the feed of the drill head 208a through the pressurised air cylinder 208 is switched on. The key switch 210 controls a pressurised air pipe via which the impingement of pressurised air on the cylinder 208 is initiated. At 211, an end switch 211 pneumatically operated at the component 201 is shown, by means of which the feed movement of the drill head 208a is switched off and the return stroke of the drill head through the pressurised air cylinder 209 is initiated.

Further, a delay means is provided, by which the drilling apparatus is only switched off when the drill 206 is withdrawn from the bore. The end switch 211 initiates the return stroke of the drill, wherein the delay means triggers the switching off of the drill only after a certain return stroke, to prevent the drill from becoming caught in the bore.

The drilling and suction apparatus 200 is formed such that after actuating the key switch 210, the drilling and suction processes run automatically. The apparatus functions as follows. First, with moved out gripping claw 12, the device is applied to a shock absorber or spring strut, whereupon the pressurised air ratchet 16, which extends approximately parallel to the housing 212, as FIG. 9B shows, is switched on via the actuating switch 16b, so that the tension bolt 11 pulls the gripping claw 12 tight at the spring strut 1, wherein the annular seal 203a on the front end of the drilling and suction apparatus 200 comes to bear on the circumference of the spring strut and the suction chamber 204 is sealed off. Hereupon, via the key switch 210, the drilling process is initiated, whereupon the drill head 208a is moved forward by the pressurised air cylinder 209 while simultaneously, the drilling apparatus 208 is switched on, When the drill stroke is achieved, the return stroke movement of the drill head is initiated via the end switch 211, and the drilling apparatus 208 is switched off with a time delay, while simultaneously the suction of the liquid from the spring strut via the suction chamber 204 and the suction tube 205 is switched on. At the sight tube 205a, the suction can be monitored. After the suction process is completed, the means for generating low pressure (not shown), which is connected to the drilling and suction apparatus 200, is automatically switched on, whereupon by switching the pressurised air ratchet 16 via the switch button 16c and reactuation of the switch 16b, the gripping claw 12 is moved out and the apparatus can be released from the spring strut.

The whole of the control and actuation of the drilling and suction apparatus takes place pneumatically, so that the apparatus corresponds to the explosion prevention regulations. From the housing 212 of the drilling and suction apparatus 200, additionally to the air pipes 205 and 208b shown, there run further pneumatic control pipes (not shown) for connecting to the low pressure source (not shown) and to a pneumatic control switch.

The gripping device with the driving means 16 is actuated separately from the drilling and suction apparatus 200, while the drilling and suction process is initiated via the pneumatic key switch 210, so that no special switches are required for the drilling process and the suction process.

As liquid is drawn off via the drilled opening from a closed space in the spring strut 1, after a certain amount of time, the same low pressure is reached in the spring strut as in the low pressure source (not shown), so that the suction process cannot be continued. A means 205b is provided in the extraction hose 205, by means of which the atmospheric pressure can be established in the suction pipe 205 and in the spring strut, whereupon the suction process can be continued by the low pressure generated by the low pressure source, Pulse operation of this kind is continued until no more liquid can be found in the transparent sight hose 205a.

It is also possible, for example via the means 205b, to connect pressurised air to the pipe 205, especially when paste-like or jelly-like material must be removed from the spring strut or front a shock absorber, instead of liquid.

Further, an alarm, especially an acoustic one, can be triggered, for example by means of a pneumatic sensor, when the suction process is completed and only air is still being drawn off via the pipe 205.

Different variations of the described configuration are possible. For example, instead of the pressurised air ratchet 16. an electric motor can be provided as the driving means for the gripping device, which is arranged in extension of the cylindrical housing 10 so that a more compact configuration results. Such an embodiment is possible when no explosion prevention must be provided. This also applies for the driving means for the prestroke and return stroke of the drill head.

Instead of the drilling apparatus 208 with angular-shaped drill head 208a, a drilling apparatus can also be displaceably guided in the guide housing 201a, whose cylindrical housing extends in the axial direction of the drill.

Further, the gripping claw 12 can be fixedly mounted on the tension bolt 11, or it can be formed in another way to be exchangeable.

The gripping device described can also be provided in other drilling apparatuses or tools in an advantageous way. In the same way, the described drilling and suction device 200 can also be advantageously used in connection with another gripping device.

1. A drilling and suction apparatus having a gripping device, especially for opening shock absorbers and spring struts by drilling, comprising:
a housing having a longitudinal bore for housing a tension bolt which engages with a threaded spindle, the threaded spindle drivable in two rotating directions by a rotatable driving device, which drives the tension bolt axially in a first direction or a second opposite direction depending on which of the two rotating directions, wherein a gripping claw is fixed to a front end of the tension bolt, and
wherein a holder for the drilling and suction apparatus is formed on the housing.

2. The apparatus according to claim 1, wherein the rotatable driving device of the gripping claw is formed as a pressurised air-driven ratchet, which is fixed to be moveable laterally on the housing and engages with the threaded spindle.

3. The apparatus according to claim 1, wherein the gripping claw is releasably fixed on the tension bolt and comprises a first section positioned at an angle to a second section to form a hook.

4. The apparatus according to claim 3, wherein the front end of the tension bolt is provided with a front end opening extending transversely to the axial direction and merging into a throughhole extending transversely to the axial direction, which is constricted on one side by a bar and wherein a bent engaging portion is formed on the gripping claw that engages the front end opening of the tension bolt.

5. The apparatus according to claim 4, wherein a ball stop is provided at the tension bolt, which engages with a recess on the engaging portion of the gripping claw for the fixing thereof.

6. The apparatus according to claim 1, wherein the holder is formed on the housing by a laterally protruding annular shoulder which extends in a direction a first section or a second section of the gripping claw.

7. The apparatus according to claim 1, wherein a component part is provided which is inserted in the holder and which comprises a drill connected to a drill head.

8. The apparatus according to claim 7, wherein a guide housing is mounted on the component part.

9. The apparatus according to claim 8, wherein an end switch is provided on the component part for controlling movement of the drill head.

10. A gripping device, especially for an apparatus for opening shock absorbers by drilling, comprising:
a housing having a longitudinal bore for housing a tension bolt which engages with a threaded spindle, the threaded spindle being drivable in two rotating directions by a driving device.
wherein at the front end of the tension bolt a gripping claw is fixed. and
wherein at the housing a holder for a drilling apparatus is formed.

11. A drilling and suction apparatus, especially for drawing off liquid from shock absorbers and spring struts of a motor vehicle, comprising:
a guide housing in which a drill head with a drill mounted thereon can be moved by a driving unit, which is mounted in the guide housing and supported by the guide housing,
wherein a suction chamber is formed in the guide housing proximate a front end of the drill.
